(19) United States
(12) Patent Application Publication
(10) Pub. No.: US 2022/0055483 A1
(43) Pub. Date: Feb. 24, 2022

(54) FIRST SERIES THEN PARALLEL BATTERY PACK SYSTEM

(71) Applicant: Chunyi Wang, Seattle, WA (US)

(72) Inventor: Chunyi Wang, Seattle, WA (US)

(21) Appl. No.: 17/506,906

(22) Filed: Oct. 21, 2021

Related U.S. Application Data
(63) Continuation of application No. 15/437,138, filed on Feb. 20, 2017, now abandoned.

(30) Foreign Application Priority Data
Jun. 21, 2016 (CN) 201610451398.X
Jun. 21, 2016 (CN) 201620615449.3

(51) Int. Cl. B60L 3/00; B60L 58/19; B60L 58/24; B60L 50/64

(52) U.S. Cl. CPC B60L 3/0046; B60L 58/19; H02J 7/0029; B60L 50/64; B60L 58/24

(57) ABSTRACT

This present invention provides a packing scheme for battery cells, known as FSTP (First Serial Then Parallel). That is, when building a battery pack, first the battery cells are connected in serial to reach the required voltage, then the resulted battery strings are connected in parallel to reach the required capacity. A final battery pack is thus completed. This scheme possesses the following advantages: (1) Safety of the pack against catching fire is greatly improved by an order of magnitude, since each of every cell in the pack has been monitored; (2) Total cost is contained within acceptable level; (3) Cell strings can be easily switched out of the pack, resulting in removing faulted cells instantly without significantly impacting operation. And the costly active battery balancing becomes unnecessary.

### CROSS-REFERENCE TO RELATED APPLICATION(S)

The present application claims priority to Chinese Patent Application Nos. 201610451398.X and 201620615449.3 filed on Jun. 22, 2016, entitled “Battery Management System and Method” and “Battery Management System”, respectively, the entire disclosures of which are incorporated by reference herein.

### BACKGROUND OF THE INVENTION

### 1. Field of Invention

The present invention relates to the field of battery cell configuration for electric vehicles and battery pack stations, especially for such safety crucial applications as space flight, aviation and submarines.

### 2. Description of Related Art

It is a common practice of today's battery pack industry to connect small cells in parallel first to form modules with a large capacitance. The modules are then connected in series to reach the target voltage of the battery.

The parallel-connected cells are hard-wired. On several occasions, one of the connected cells has faulted and short-circuited, causing a large short-circuit current. This large short-circuit current has been identified the root cause of many fire accidents in the electric vehicles.

Parallel connection of cells may generate an internal current. For example, if two cells are connected in parallel, and the electromotive forces (EMF) of the batteries are exactly equal, then the internal current would be zero. However, if the cells have a 0.01-volt (V) difference, and the combined resistance of one cell and its connecting conductor is 5 milliohms (mΩ), then the resulting internal current would be 1 ampere (A) if the equivalent circuitry model is applicable. At 1 A, this resulting current can no longer be considered trivial. With aging of the connected cells, the EMF differences may eventually cause the cell to short-circuit. The induced internal current may even cause the batter pack to combust. Because the parallel connection is hard-wired, there is no way to stop this internal current. This internal current is responsible for the self-discharging of the battery packs, which is a well-known issue.

There is a phenomenon called thermal runaway which describes how lithium batteries may heat up until they burst into flames. In this case cutting off electrical connection would have no effects in stopping the fire. In order to prevent fire accidents, a battery management system (BMS) would need to be implemented to detect over-heating of any cells at an early stage.

Unfortunately, in today's battery packs there are usually much fewer temperature sensors than cells. It has been a common practice that several cells share one temperature device. When a cell in the mid-way of two temperature sensors gets heated up, by the time one temperature device senses the abnormal reading, the thermal runaway has already started. This has been another major cause of many fire accidents happened in EV (Electrical Vehicle) battery packs today.

Battery cell balancing has been very popular for a few years. This technique calls for accurate measurement of cell voltages. The measuring accuracy could be as high as 1-3 mV. However, expensive high-precision IC's (integrated circuits) are required which increase BMS cost considerably.

Based on the foregoing, there is a need in the art for a battery pack in which no cells are connected directly in parallel. Hard-wired, directly connected in parallel cells are bad practice for applications with high reliability and safety requests.

### SUMMARY OF THE INVENTION

The present invention is a battery pack wherein multiple battery cells are first connected in series to form a battery string. In the preferred embodiment, multiple battery strings are created then all battery strings are connected in parallel.

In the preferred embodiment, each battery string is further comprised of an integrated circuit, the string BMS (battery management system), to act as a battery management system for the string. The string BMS is configured to monitor the voltage and temperature of each cell in the string, measure the total current for the battery string, record all faults, calculate the status of charge for the battery string, calculate the status of health for the battery string, calculate the status of power for the battery string, and calculate the total voltage of the battery string.

In the preferred embodiment, all the string BMS's are in communication with a main BMS (battery management system)via a CAN (controller area network) bus. The main battery management system is further configured to calculate voltage, current, and status of charge for the battery pack.

In the preferred embodiment, each battery string is further provided with a switching relay. If the main battery management system detects a fatal fault within any of the battery strings, the main battery management system will cut the faulty strings out of the circuit by disconnecting the string via the switching relay.

In the preferred embodiment, the sampling circuit of the string BMS (battery management system) will further comprise of temperature devices to monitor the temperature of each battery cell within the string. In the embodiment, the recorded temperatures will be processed by the string BMS (battery management system) and faults can be detected if temperatures are recorded outside of a specified threshold. The main BMS (battery management system) can then disconnect the faulty strings via the switching relays.

In the preferred embodiment, all the switching relays in the battery strings are disconnected when the battery is not in use. Disconnecting the switching relays prevents internal current and self-discharging to greatly reduce the risk of the battery pack catching on fire.

In the preferred embodiment of the battery pack, the sampling circuits will be able to measure the voltage with an accuracy of 0.01-volts.

In the preferred embodiment, when space is not an issue and R<10 where R is the ratio of the pack capacity over cell capacity, the string BMS (battery management system) can be provided on a printed circuit board. In an embodiment, when space is limited and R>10 , the string BMS (battery management system) can be provided on a SoC (system on chip) or a SiP (system in package) integrated circuit (IC).

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a schematic view of the first series then parallel battery pack system, according to an embodiment of the present invention;

FIG. 2 is a schematic view of the first series then parallel battery pack system, according to an embodiment of the present invention; and

FIG. 3 is a schematic view of the first series then parallel battery pack system, according to an embodiment of the present invention.

### DETAILED DESCRIPTION OF PREFERRED EMBODIMENTS

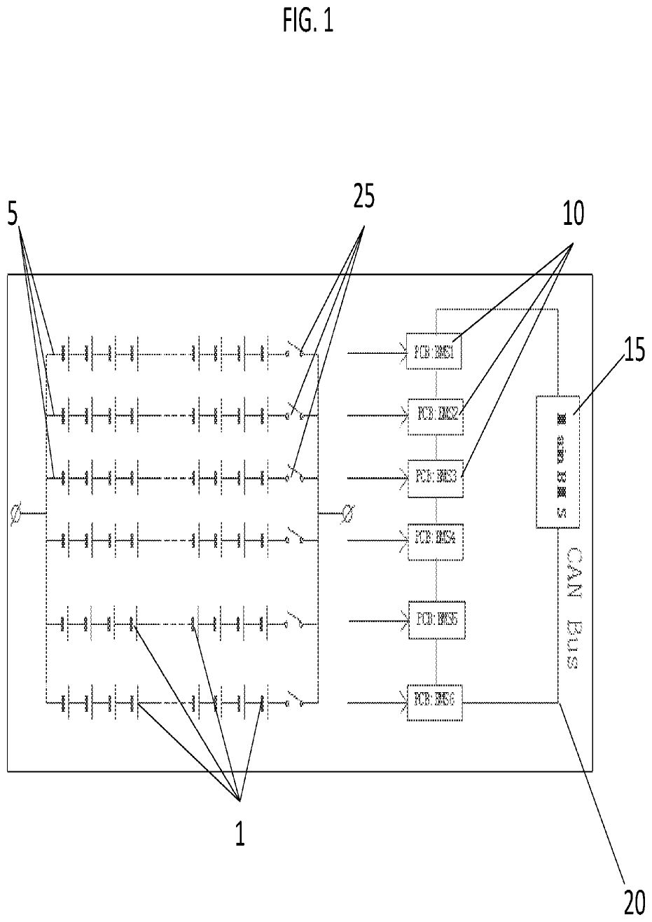

Preferred embodiments of the present invention and their advantages may be understood by referring to FIGS. 1-3, wherein like reference numerals refer to like elements.

The present invention is a new packing scheme for battery cells, wherein the battery cells are first connected in series to obtain a required voltage, then the resulting battery strings are connected in parallel to obtain a required capacitance. The packing scheme of the present invention will herein be referred to as First Serial Then Parallel or FSTP.

With reference to FIG. 1, a system diagram is shown for an FSTP pack wherein six cell strings 5 are connected in parallel. In the embodiment, each cell string 5 will comprise of any number of battery cells 1 necessary to obtain the required voltage. In an embodiment, each cell string 5 is assigned a PCB (printed circuit board) to function as a string BMS (battery management system) 10 for that string. Using a PCB to function as a string BMS 10 will work well in circumstances wherein the cell capacity is large and there is sufficient space for battery packs. In an example, a commercial bus utilizing a battery pack of 640 Volts (V) and 120 amp hours (AH) may be comprised of six strings 5 of 200 cells 1 connected in parallel, wherein each cell 1 is 20 AH.

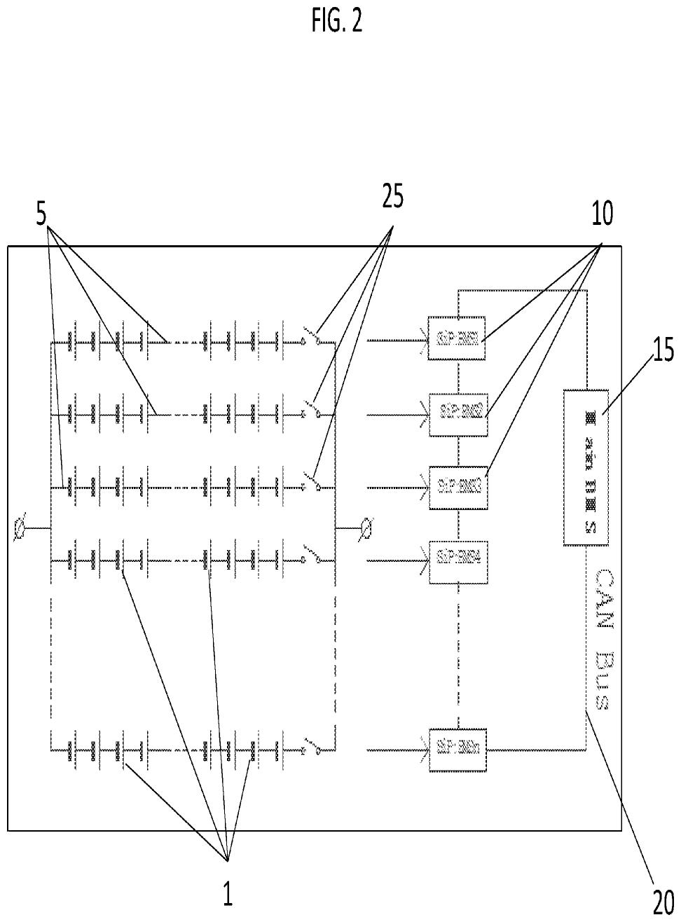

With reference to FIG. 2, an embodiment of the present invention is shown, wherein any number of cell strings 5 may be connected in parallel to obtain a required capacitance. In this configuration, the “application specific integrated circuits (ASIC)”, such as the “system in package (SiP)” or the “system on chip (SoC)”, may be utilized as a string BMS 10. Using a SiP or SoC to function as a string BMS 10 is desirable when space is limited. For example, a passenger car may utilize a battery pack of 336 V and 154 AH which may be comprised of 70 strings, each monitored by an SiP or SoC. Each string may consist of 96 cells 1 connected in serial, wherein each cell 1 is 2.2 AH.

In determination of the proper string BMS types, let R₀ be a parameter decided by cell capacity, available space and cost. For example R₀=10 applies for many cases. When (pack capacity/cell capacity)<R₀, the String BMS's can be built using PCBs. This situation is true for most commercial buses and trucks where the cell capacity is usually large and the space for battery packs is not a problem. When (pack capacity/cell capacity)>R₀, the String BMS's should be built using ASIC's (Application Specific Integrated Circuits), such as SiP or SoC. This situation is true for passenger cars, especially those using battery packs of 18650 cells with a capacity of 2-3 kWH, and the space is quite stringent.

In reference to FIGS. 1-2, Each of the string BMSs 10 will monitor the voltage, temperature of each individual cell, and current of the entire string. In the embodiment, the string BMSs will also function to record any faults, calculate the status of charge, calculate status of health, calculate status of power, and calculate total voltage for each string. In an embodiment, multiple string BMSs 10 are provided for each string to ensure accurate measurements of each cell. Furthermore, the string BMSs 10 will send data concerning status and faults to a main BMS 15 via the CAN (controller area network) bus.

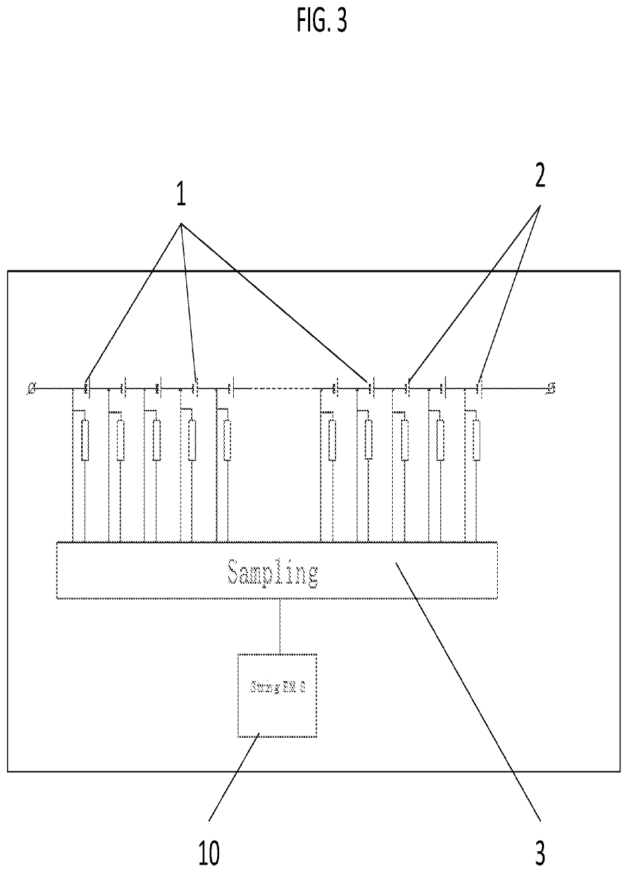

In reference to FIG. 3, in the preferred embodiment, each cell 1 will be attached by a temperature device 2. The temperature device may be a simple thermal resistor as is known in the art. One wire will connect every joint point in the cell string to the temperature device, and another wire will connect each joint point to a sampling circuit 3. The sampling circuit will measure the temperature and voltage of each cell and send the data to the String BMS 10, wherein the total voltage and state of charge of the string will be calculated and sent to the main BMS (not shown in FIG. 3).

The purpose of the sampling circuit monitoring voltage is to determine if the cell voltage goes beyond the maximum voltage or under minimum voltage for the cell. For this task, the accuracy of 0.01V is enough for voltage measurement. Therefore, expensive sampling IC's could be spared, thus lowering cost considerably. This argument applies to any BMS without using battery balancing method, which calls for voltage accuracy of 1-3 mV.

Again, with reference to FIGS. 1-2, in the preferred embodiment, the main BMS 15 will be responsible for calculating the total current, voltage, and state of charge for the entire battery pack. Additionally, the main BMS 15 is responsible for recording all warnings received from the string BMSs 10. In the event of a faulty cell, the main BMS will cut out the string 5 containing the faulty cell by opening a switch relay 25 connected to that string.

By cutting off the faulty cell, the active cell balancing system (which is often very expensive), as it is known in the art, will not be required. Since the pack comprises of many strings, cutting one string out would not reduce the power considerably, and a user would be able to continue using their device or vehicle until they find time to fix the problem.

In the preferred embodiment, when the battery is not in use, all the switch relays 25 will be disconnected. Disconnection of the switch relays will eliminate the possibility of self-discharging and internal current to greatly reduce the chance of catching fire.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A battery pack comprising:
a. two or more battery cells connected in series to form a battery string;
b. two or more battery strings connected in parallel, each battery string further comprising:
i. a switching relay; and
ii. an integrated sampling circuit provided as a string battery management system configured to:
1. monitor the voltage and temperature for each of the two or more battery cells;
2. measure current for the battery string;
3. record all faults;
4. calculate status of charge for the battery string;
5. calculate status of health for the battery string;
6. calculate status of power for the battery string;
7. calculate total voltage for the battery string; and
c. a main battery management system in communication with the two or more battery strings configured to:
i. communicate with the string battery management systems via a system controller area network bus;
ii. cut out faulty strings;
iii. calculate status of charge for the battery pack;
iv. calculate voltage for the battery pack; and
v. calculate current for the battery pack.

2. The battery pack of claim 1, wherein the switching relays of the two or more battery strings are disconnected when the battery pack is not in use.

3. The battery pack of claim 1, wherein the integrated sampling circuit can measure voltage with a 0.01-volt accuracy.

4. The battery pack of claim 1, wherein the string battery management system is a SoC (system on chip) or SiP (system in package) IC when R>10 where R is the ratio of pack capacity over cell capacity.

5. The battery pack of claim 1, wherein the string battery management system is a printed circuit board when R<10.
